(19) United States
(12) Patent Application Publication
(10) Pub. No.: US 2007/0156928 A1
(43) Pub. Date: Jul. 5, 2007

(54) Token passing scheme for multithreaded multiprocessor system

(76) Inventor: Makaram Raghunandan, Northboro, MA (US)

Correspondence Address: INTEL CORPORATION;c/o INTELLEVATE, LLC, P.O. BOX 52050, MINNEAPOLIS, MN, 55402, US

(21) Appl. No.: 11/322,818

(22) Filed: Dec. 30, 2005

(51) Int. Cl. G06F 15/16

(52) U.S. Cl. 709/251

(57) ABSTRACT

A token passing mechanism reduces unnecessary thread stalls in a multithreaded microprocessor system. In a multithreaded microprocessor system, in order processing for critical sections is managed through the use of tokens with access to each critical section restricted to the thread having the token associated with the critical section. A token handler maintains a token skip indicator per token that allows a thread that does not need a critical section to forward the token associated with that critical section to a next thread prior to reaching the critical section.

### FIELD

This disclosure relates to multithreaded multiprocessor systems and in particular to a token passing mechanism that reduces unnecessary thread stalls.

### BACKGROUND

A network processor is a programmable device that is optimized for processing packets at high speed. As the processing time available for processing received packets decreases in proportion to the increase in the rate at which packets are transmitted over a network, a network processor may include a plurality of programmable packet-processing engines to process packets in parallel. The packet-processing engines run in parallel, with each packet processing engine handling packets for a different flow or connection which can be processed independently from each other.

To hide latency associated with memory accesses, each packet processing engine may support multiple threads of execution. Multi-threading minimizes the time that the network processor is stalled. Each thread has its own context (registers and program counter) and context-swapping is supported between threads. While one thread is waiting for a memory access to complete, another thread can execute instructions. Ordering of packets for the same flow is enforced by a token passing mechanism implemented using signals.

One known problem with using multiple threads of execution to process packets in parallel is synchronizing updates to shared resources. For example, in an application that classifies packets into flows, packets belonging to the same flow may be metered using a token bucket algorithm, with a separate token bucket for each flow. The parameters associated with the token bucket, such as the number of tokens and update rate are stored in a per-flow data structure. Each thread reads, modifies, and writes the parameters in the flow data structure once per packet.

Multiple threads processing packets in the same flow must synchronize any update to the per flow data structure. Thus, each thread needs to get exclusive access to the data structure, read, modify and write it back to memory. The process of getting exclusive access to the per flow data structure and modifying it is called a “critical section”.

The token passing scheme can ensure order of the packets at an input and an output of the network processor, maintain critical sections and maintain order of processing of a critical section. In a scheme that performs ordered processing of threads, the token is passed from one thread to the next thread, with the order of the threads being pre-determined. A thread that has a critical section, waits for the token, completes its critical section processing when it has the token and then forwards the token to the next thread. This read-modify-write critical section operation impacts performance of processing packets. One thread prevents subsequent threads from operating until that thread is completed its critical section processing.

This scheme works well in cases where all of the packets require very similar or identical processing, that is, all packets require the same set of critical section processing and in the same order, all critical sections are small and all critical sections need to be executed in order.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a network processor;

FIG. 2 is a logical view of fast-path processing in the network processor shown in FIG. 1;

FIG. 3 is a processing flow graph illustrating processing stages through which a packet travels;

FIG. 4 is a block diagram illustrating state information maintained by a token handler for each thread;

FIG. 5 is a flow chart of an embodiment of a token handler for managing token passing on behalf of threads; and

FIG. 6 is a flow chart of an embodiment of a method for using the token handler.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

In the case that a thread does not need to perform critical section processing for a particular packet, for example, when packet processing can take multiple logical paths, a thread still waits for the token to arrive and then forwards it to the next thread. Thus, some threads and processors will be unnecessarily stalled waiting for a previous thread to complete its processing. Also, in some cases, the token may be received while the thread is busy performing packet processing unrelated to the critical section and the token is not passed onto the next thread until the thread completes its processing.

The token passing scheme according to an embodiment of the present invention reduces unnecessary thread stalling. This enhances the benefit of using token passing particularly when very different types of processing workloads are possible.

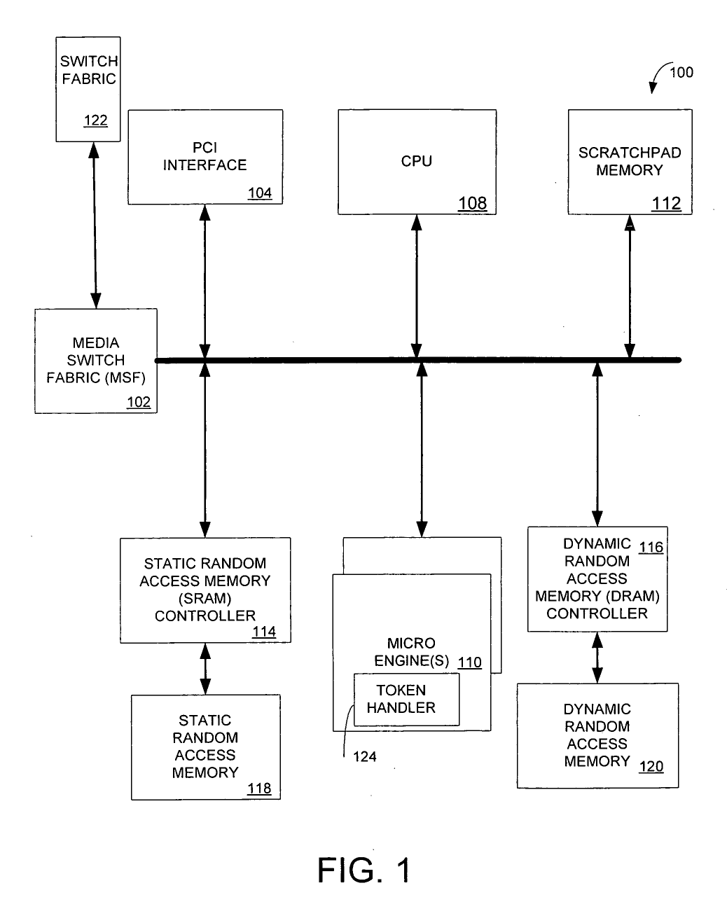

FIG. 1 is a block diagram of an embodiment of a network processor 100. The network processor 100 includes a Media Switch Fabric (MSF) interface 102, a Peripheral Component Interconnect (PCI) interface 104, memory controllers 114, 116, memory 112, 118, 120, a processor (Central Processing Unit (CPU)) 108 and a plurality of micro engines 110.

In an embodiment, each micro engine 110 is 32-bit processor with an instruction set and architecture specially optimized for fast-path data plane processing. Network processing has traditionally been partitioned into control-plane and data-plane processing. Data plane tasks are typically performance-critical and non-complex, for example, classification, forwarding, filtering, headers, protocol conversion and policing. Control plane tasks are typically performed less frequently and are not as performance sensitive as data plane tasks, for example, connection setup and teardown, routing protocols, fragmentation and reassembly.

In one embodiment, there are sixteen multi-threaded micro engines 110, with each micro engine 110 having eight threads. Each thread has its own context, that is, program counter and thread-local registers. Each thread has an associated state which may be inactive, executing, ready to execute or asleep. Only one of the eight threads can be executing at any time. While the micro engine 110 is executing one thread, the other threads sleep waiting for memory or Input/Output accesses to complete. In one embodiment, context switching is non-pre-emptive, that is, a thread swaps out when it voluntarily yields to other threads. Memory latency inefficiency is reduced by having one thread execute while the other threads are waiting for a memory operation with a long latency to finish. The next thread that is ready to execute is swapped in round robin order. The round robin order is thread 0, 1, 2 . . . 7 followed by thread 0 again. Each micro engine 110 includes an embodiment of a token handler 124 which manages token passing on behalf of threads according to the principles of embodiments of the present invention.

The CPU 108 may be a 32 bit general purpose Reduced Instruction Set Computer (RISC) processor which may be used for offloading control plane tasks and handling exception packets from the micro engines 110.

The Static Random Access Memory (SRAM) controller 114 controls access to SRAM 116 which is used for storing small data structures that are frequently accessed such as, tables, buffer descriptors, free buffer lists and packet state information.

The Dynamic Random Access Memory (DRAM) controller 116 controls access to DRAM 120 for buffering packets and large data structures, for example, route tables and flow descriptors that may not fit in SRAM 116.

The embodiment of the network processor 100 shown in FIG. 1 includes both SRAM 116 and DRAM 120. In another embodiment, the network processor 100 may include only SRAM 116 or DRAM 120.

The scratchpad memory 112 provides hardware-assisted ring buffers for communication between micro engines 110. In an embodiment, the scratchpad memory 112 is 16 Kilobytes. Control Status registers that may be accessed by the micro engines 110 are stored in the scratchpad memory 112.

The MSF interface 102 buffers network packets as they enter and leave the network processor 100. The packets may be received from and transmitted to Media Access Control (MACs)/Framers and switch fabrics 122. In another embodiment, the MSF interface 102 may be replaced by a MAC with Direct Memory Access (DMA) capability which handles packets as they enter and leave the network processor 100 or a Time Division Multiplexing (TDM) Interface.

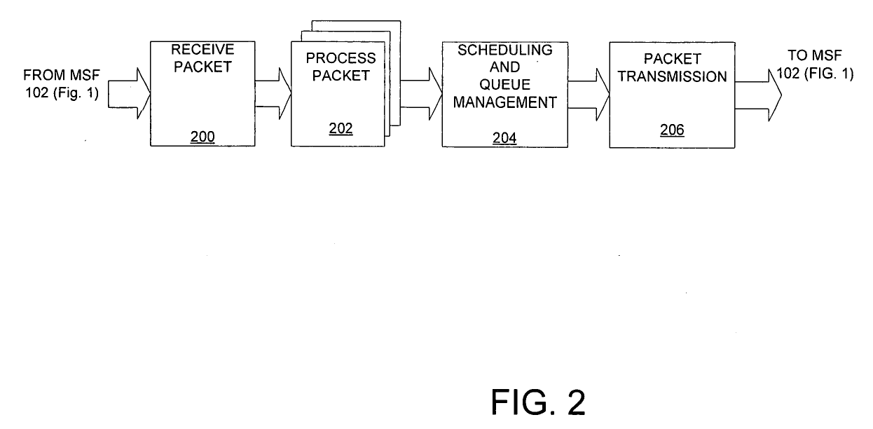

FIG. 2 is a logical view of fast-path data plane processing for a received packet in the network processor 100 shown in FIG. 1. FIG. 2 will be described in conjunction with FIG. 1. The Media Switch Fabric (MSF) interface 102 receives packets as fixed size segments and buffers them in a receive buffer.

A packet receive module 200 reassembles the fixed-size segments received from the MSF interface 102 into complete packets and stores the packets (including headers and payload) in DRAM 120. In an embodiment in which the MSF interface 102 is replaced by a MAC with DMA capability, the packet receive module 200 receives packets directly from the MAC and thus does not need to reassemble the fixed-size segments. The packet receive module 200 also stores per packet state information in a packet descriptor associated with the packet in SRAM 118 and stores a handle (pointer to a location in memory) in a ring buffer in the scratchpad memory 112 that identifies where the packet is stored in DRAM 120. After the packet has been received and its handle stored in a ring buffer, it is ready to be processed.

Packet processing 202 is performed in the micro engines 110. Multiple micro engines 110 run in parallel and one of the eight threads in each micro engine 110 handles one packet at a time and performs data plane processing tasks on it. Each thread reads in a message stored in a ring buffer in the scratchpad memory 112. The message includes a packet handle (pointer to a location in DRAM storing the packet) and other per-packet state.

Using the packet handle, the thread reads headers from the packet stored in DRAM 120 and the packet descriptor stored in SRAM 118 and performs various packet-processing tasks. The packet headers, descriptor and other per packet state is read into the micro-engine 110 once, cached in local memory or registers and in the micro engine 110 and used by all the packet processing tasks. Access to data structures that are shared across multiple packets may be synchronized across multiple micro-engines 110. If the packet processing tasks result in modifying the packet header, the modified header is written back to DRAM 120 and the modified descriptor is written back to SRAM 118. After the packet processing tasks have been completed, the thread writes an enqueue message that includes the packet handle and associated transmit queue information for the packet to a queue in the scratchpad memory 112 that is serviced by the scheduling and queue management module 204.

The scheduling and queue management module 204 determines the order in which packets are dequeued and sent to the transmit module 206. The dequeue packet handles are written to a queue in the scratchpad memory 112 which is serviced by the transmit module 206.

The transmit module 206 receives a packet handle from the scheduling and queue management module 204 and schedules packets for transmission. The transmit module 206 segments the packet into fixed size segments and transmits them over the MSF interface 102.

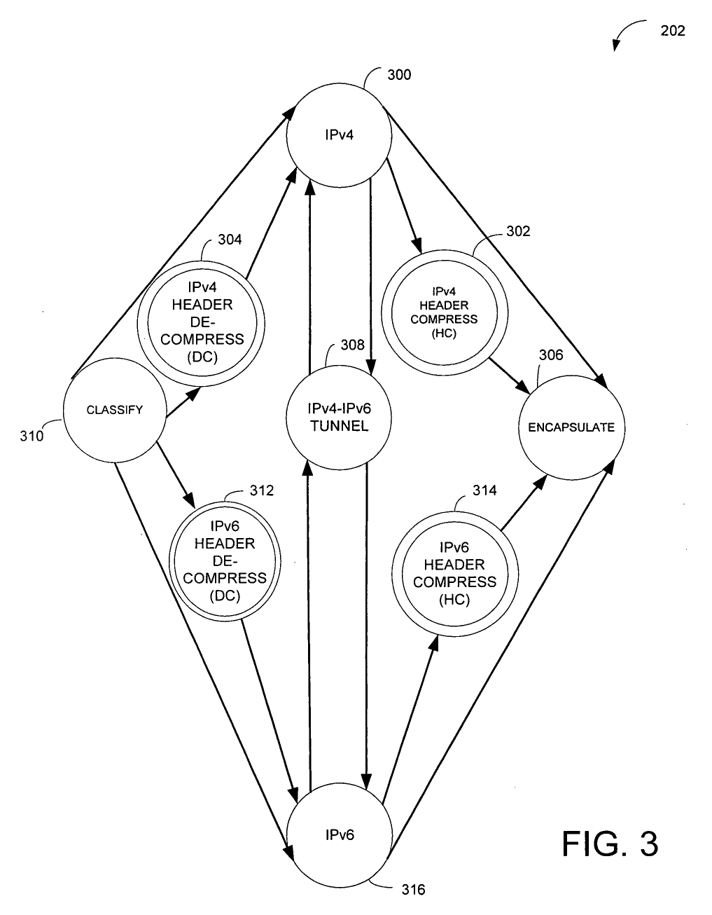

FIG. 3 is a processing flow graph illustrating processing stages in the packet processing block 202 shown in FIG. 2. Packet processing stages perform high-level protocol specific functions on a packet such as Internet Protocol version 4 (IPv4) forwarding and Internet Protocol version 6 (IPv6) forwarding. As discussed in conjunction with FIGS. 1 and 2, multiple threads across micro engines run in parallel to process packets using a run-to-completion model.

A packet processing thread processes one packet at a time performing processing tasks on the packet. Packet processing is decomposed into modular functions or micro blocks (stages). Each micro block (stage) performs a discrete high-level function on a packet. Processing stages 304, 312, 302, 314 require packets to be processed in the order that they arrived.

The packet processing for a particular packet can take multiple logical paths dependent on the contents of the packet being processed. The classify stage 310 inspects the packet to determine the action to be taken on the packet. For example, the classify stage 310 may store the Media Access Control (MAC) and Internet Protocol (IP) headers in the local memory in the micro engine 110, parse the IP header in the packet and classify the type of IP as version 4 (v4) or version 6 (v6). The packet processing continues in an IPv4 stage or an IPv6 stage based on examination of an IP type in the IP header included in the packet. In this example, a received packet may include Internet Protocol version 4 (IPv4) or Internet Protocol version 6 (IPv6) headers which may need decompression. Furthermore, the IP (IPv4/IPv6) headers may need to be decompressed before the packet is forwarded.

The encapsulate stage 306 reads the destination MAC address from a next hop address data structure stored in SRAM 118 (FIG. 1). The MAC header stored in local memory is modified with the next hop MAC address and the modified MAC header is written back to DRAM 120 (FIG. 1).

A packet's header may be compressed to minimize packet length. For example, an IP header may be compressed to minimize packet length in a protocol such as Voice over Internet Protocol (VoIP) where the payload is relatively small in comparison to the header. Compression of headers may also be used for links that have a high packet-loss rate and small packet size such as wireless links, to allow efficient use of bandwidth on these links. Header compression relies on the information in the header being the same or seldom changing in packets belonging to the same flow so that a compressed header may be uncompressed by using the header of the previous packet.

Methods for compressing headers are well known to those skilled in the art. For example, a method for compressing an IP header is described in “IP Header Compression”, Network Working Group, Request for Comments (RFC) 2507, February 1999. Whether an IP header is compressed may be determined from the L2 layer, for example, from the Ethernet header or the Point-to-Point Protocol (PPP) header.

Information that does not change between consecutive packets in the flow need not be transmitted and information such as sequence numbers which change predictably between packets can be encoded incrementally so that only the difference between the packets is the sequence number that is transmitted with each packet. The first packet may be sent with all the information in the header and subsequent packets have compressed headers with incremental changes to the header. For example, for a given VoIP session, the IP source address remains a constant, hence the 32-bit IPv4 source address may be eliminated thereby compressing the header by 32 bits.

As compression and decompression of headers requires that the packets be processed in order of arrival, the compression and decompression micro-blocks (stages) in the flow graph shown in FIG. 3 are considered critical sections. In each of these critical sections (micro blocks (stages) IPv4 header decompression 304, IPv6 header decompression 312, IPv4 header compression 302 and IPv6 header compression 314) the packets must be processed in order of arrival. To ensure in-order processing, a token is assigned to each critical section. Only the thread that currently has the token can execute the critical section.

Not all packets require the same processing because packet processing can take multiple logical paths. In the example shown, the packet processing can follow 16 different logical paths from the classify stage 310 to the encapsulate stage 306. The 16 different logical paths are shown below in Table 1, with blocks having a critical section indicated by *.

TABLE 1

| | | Critical |
|---|---|---|
| No. | Path | Secs. |
| 1. | Classify-IPv6-Encap | 0 |
| 2. | Classify-IPv4-Encap | 0 |
| 3. | Classify-IPv4-tunnel-IPv6-Encap | 0 |
| 4. | Classify-IPv6-tunnel-IPv4-Encap | 0 |
| 5. | Classify-IPv6-IPv6HC*-Encap | 1 |
| 6. | Classify-IPv6DC*-IPv6-Encap | 1 |
| 7. | Classify-IPv4-IPv4HC*-Encap | 1 |
| 8. | Classify-IPv4DC*-IPv4-Encap | 1 |
| 9. | Classify-IPv4DC*-IPv4-tunnel-IPv6-Encap | 1 |
| 10. | Classify-IPv4-tunnel-IPv6-IPv6HC*-Encap | 1 |
| 11. | Classify-IPv6DC*-IPv6-tunnel-IPv4-Encap | 1 |
| 12. | Classify-IPv6-tunnel-IPv4-IPv4HC-Encap | 1 |
| 13. | Classify-IPv6DC*-IPv6-IPv6HC*-Encap | 2 |
| 14. | Classify-IPv4DC*-IPv4-Ipv4HC*-Encap | 2 |
| 15. | Classify-IPv4DC*-IPv4-tunnel-IPv6-IPV6HC*-Encap | 2 |
| 16. | Classify-IPv6DC*-IPv6-tunnel-IPv4-IPv4HC*-Encap | 2 |

Of the 16 paths, there are four paths (numbered 1-4 in Table 1) that do not include any critical sections. There are eight paths (numbered 5-12 in Table 1) that include one critical section. There are four paths (numbered 13-16 in Table 1) that include 2 critical sections. The critical sections may be ordered critical sections, that is, threads belonging to the same flow must access and update shared data structures in the order in which they received the data packets. Thus, each of the four critical sections occurs only for a fraction of the logical paths and none of the 16 paths includes all four critical sections. For example, if a packet is classified as a standard IPv6 packet to be forwarded, it would take path 13 through two critical sections.

An embodiment of a token passing scheme may be used for hyper-task chaining (ordered processing of threads) model or a pool-of-threads (unordered processing of threads) model. In the Hyper Task Chaining model, all threads must logically pass through all micro blocks (stages) that contain critical sections. Prior to entering a critical section, a thread waits for the token, completes the critical section while it has the token and forwards the token to the next thread. In the Pool of Threads model, threads operate independently and packet ordering is maintained through the use of an output re-ordering buffer. Ordering constraints on critical sections are managed through the use of mutual exclusion.

Hyper Task Chaining is a pipelining approach to packet processing. A networking application is broken down into a series of tasks which are mapped to stages in a pipeline. Each stage in the pipeline has a predetermined time duration. Each thread of a micro engine 110 processes the series of tasks on the packet. Packet ordering is obtained by strict ordering of threads to incoming packets, for example, if thread 1 works on the first packet, thread 2 works on the second packet, and so on.

Ordering of packets for the same flow is maintained by only allowing the thread that has a token to enter the critical section associated with the token. In the example shown in Table 1, when the processing tasks shown in FIG. 3 are implemented using the hyper task chaining model, each thread logically passes through all four critical sections, even though the maximum number of critical sections that any thread will execute is two. A thread that is processing a packet that does not require executing the task with the critical section, may implement a “token bypass” that waits for the previous thread to complete processing its critical section and then forwards the token to the next thread.

In an embodiment of the invention, in order to reduce thread idle time due to the “token bypass”, while waiting for a token that may be not be required by the thread, a token handler 124 manages token passing on behalf of threads. The token handler 124 maintains state information about tokens that are skipped, holds a token until it receives a skip notification and forwards a token when it arrives. The token handler 124 replaces “token bypass” code in each thread used for passing a token that is not required by the thread to the next thread, which results in unnecessary stalling of threads in the hyper chaining programming model. The token handler 124 (FIG. 1) may be implemented in hardware or as a lightweight thread, that is, a thread that has less contextual information that needs to be saved than a normal thread.

Each block in the packet processing task diagram that has a critical section, that is, requires packets to be processed in the order they arrive is assigned a token (inter-thread signal). In the example in FIG. 3, four tokens are assigned, token 1 is assigned to IPv4 decompression 304, token 2 is assigned to IPv6 decompression 312, token 3 is assigned to IPv4 compression 302 and token 4 is assigned to IPv6 compression 314.

A thread determines at some point in time whether it needs a given token.

For example, in the flow graph shown in FIG. 3, a thread knows at the end of the classify stage 310 whether it needs to go through a critical section to decompress an IPv6 or IPv4 header.

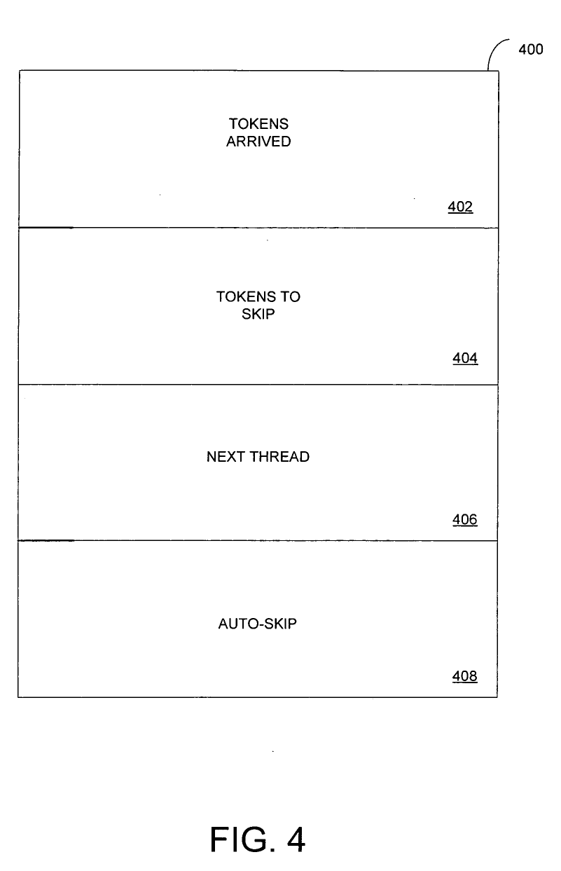

If the thread does not need a token, the thread indicates to the token handler 124 that the token can be passed directly to the next thread when it arrives. For example, in the example shown in FIG. 3, if the thread does not need to go through IPv4 header decompress 304 or IPv6 header decompress 312, it sends a skip notification for the respective tokens (token 1 and token 2) to the token handler 124. The token handler 124 maintains state information per thread about tokens that are skipped which will be described later in conjunction with FIG. 4.

A Pool of Threads programming model implements a run-to-completion model. An available thread is obtained from a free thread pool and assigned to a received packet. End-to End packet ordering maintained at the end of packet processing ensures that packets leave in the same order that they entered. End-to-end packet ordering is managed by Asynchronous Insert, Synchronous Remove (AISR). Each packet is assigned a sequence number when it is received. When processing of the packet is complete, the packet is inserted into an AISR array based on its assigned sequence number. Packets are removed from the AISR array in order of sequence number.

Partial packet order may also be maintained in the middle of the processing flow, for example, in the compress stages and decompress stages in the flow diagram shown in FIG. 3. Token passing is used to maintain order in these critical sections. A last sequence number and a skip vector is maintained for each ordered processing micro block to allow a thread to determine if it needs to wait for previous packets to arrive

In an embodiment for the packet processing block 202, shown in FIG. 2 runs on multiple micro engines 110 in parallel and each of the threads in each micro engine 110 handles one packet at a time and performs data plane processing tasks on it. Thus, the token handlers 124 in these micro engines 110 work together as a group to manage the tokens assigned to IPv4 decompression 304, IPv6 decompression 312, IPv4 compression 302 and IPv6 compression 314.

In an alternate embodiment, the token handlers 124 may be split into multiple groups, with each group managing a separate set of tokens. For example, the tasks in packet processing block 202 (FIG. 2) can be split into three sub-stages—A, B and C each of which runs on a separate set of micro engines 110. Sub-stage A may handle the classification and header-decompression tasks (310, 304, and 312), sub-stage B may handle IPv4 forwarding, IPv6 forwarding and tunneling tasks (300, 308, 316) and sub-stage C may handle header compression and encapsulation tasks (302, 306, 314). In this case, the group of token handlers 124 on micro engines in sub-stage A handle tokens 1 and 2, while the group of token handlers 124 on micro engines in sub-stage C handle tokens 3 and 4. Similarly, in other embodiments, other stages of processing such as receive, transmit and scheduling and queue management may also use a separate set of tokens.

FIG. 4 is a block diagram illustrating an embodiment of state information 400 maintained by a token handler 124 for each thread in a micro engine 110. The state information 400 includes control status registers (CSR) 402, 404, 406, 408.

In one embodiment, there are sixteen multi-threaded micro engines 110, with each micro engine having eight threads. Each thread has an associated state which may be inactive, executing, ready to execute or asleep. While the micro engine 110 is executing one thread, the other threads sleep waiting for memory or Input/Output accesses to complete. A thread swaps out when it voluntarily yields to other threads and the next thread that is ready to execute is swapped in round robin order (thread 0, 1, 2 . . . 7 followed by thread 0 again) by a thread arbiter.

The TOKENS_ARRIVED CSR 402 is a bit vector with one bit per token. The state of each bit indicates whether the thread has received the token. The TOKENS_ARRIVED CSR 402 may be used by the thread arbiter for determining which thread to wakeup. The thread arbiter clears the appropriate tokens arrived bit in the TOKENS_ARRIVED CSR 402 when it moves a swapped thread into the “ready” state.

The TOKENS_TO_SKIP CSR 404 is also a bit vector with one bit per token. The state of each bit indicates whether the respective token can be passed to the next thread.

The NEXT_THREAD indicator CSR 406 may be a single variable that indicates the next thread to which to pass the token. In one embodiment, the NEXT_THREAD indicator may be a vector with one variable per token, which allows the next thread to which to pass the token to be different for each token.

In one embodiment, the AUTO_SKIP CSR 408 is a bit that indicates whether all of the tokens should be automatically forwarded to the next thread. In another embodiment, the AUTO_SKIP CSR 408 may be a bit vector, with a bit per token that indicates if the respective token should automatically be forwarded to the next thread. After the token is forwarded to the next thread, the appropriate bit in the TOKENS_TO_SKIP CSR 404 is reset. Thus, tokens can be maintained in continuous circulation.

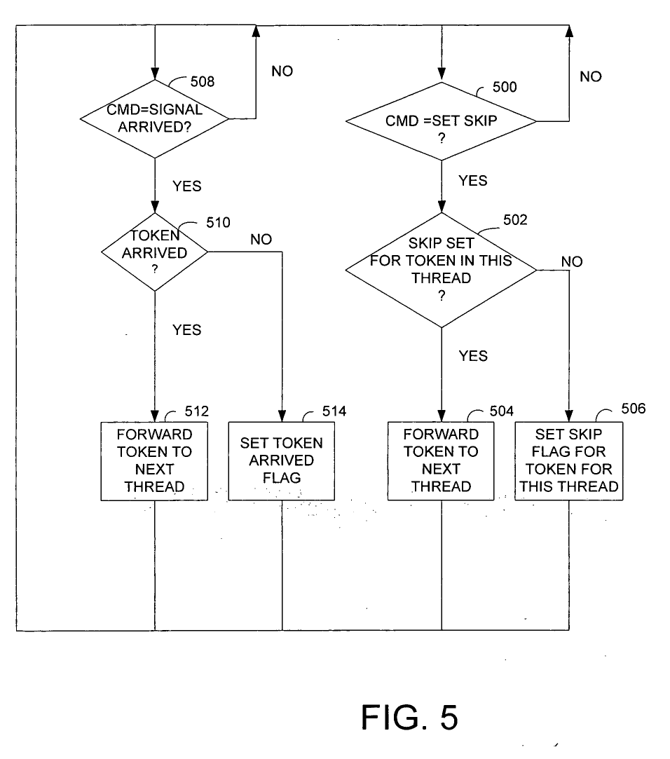

FIG. 5 is a flow chart of an embodiment of a token handler for managing token passing on behalf of threads. In one embodiment, the token handler 124 is in the micro engine 110 of the network processor 100 shown in FIG. 1. The token handler may be implemented in resistor transistor logic (RTL) or as a software algorithm stored in memory in the micro engine 110.

The embodiment of the token handler described in conjunction with FIG. 5 may be used for reducing stalls in the hyper task chaining programming model or for “mutual exclusion” for critical sections in the pool-of threads programming model.

The token handler responds to a signal arrived command and a set skip command. The signal arrived command is passed to the token handler, when an inter-thread signal is generated by a micro engine 110. The set skip command is passed to the token handler when a thread writes to the TOKEN_ARRIVED CSR 402.

At block 500, the token handler checks if the received command is a set skip command. If so, processing continues with block 502. If not, processing continues with block 508.

At block 502, the token handler checks the state of the bit corresponding to the token to be skipped in the TOKEN_ARRIVED CSR 402 to determine if the token being skipped has already arrived. If the token has already arrived, processing continues with block 504. If not, processing continues with block 506.

At block 504, the token to be skipped has already arrived and the token is forwarded to the next thread. The skip bit for this token in the TOKENS_TO_SKIP CSR is cleared. Processing continues with block 500, to wait for another command.

At block 506, the token has not arrived, the skip bit corresponding to the token is set in the TOKENS_TO_SKIP CSR 404 so that the token can be sent to the next thread when it arrives. Processing continues with block 500, to wait for another command.

At block 508, the token handler checks if the command is a signal arrived command. If so, processing continues with block 510. If not, processing continues with block 500.

At block 510, the token handler checks the TOKENS_TO_SKIP CSR 404 to determine if the skip bit was set for this token in this thread. If so, processing continues with block 512. If not, processing continues with block 514.

At block 512, the token is passed on to the next thread and the skip bit for this token in the TOKENS_TO_SKIP CSR is cleared. Processing continues with block 508.

At block 514, the bit corresponding to the token is set in the TOKENS_ARRIVED CSR for later use. Processing continues with block 508.

In the embodiment shown in FIG. 5, the signal arrived and set skip commands are processed serially. In another embodiment the processing of these commands can be performed in parallel as two separate state machines. An internal “lock” state may be included in the token handler to ensure mutual exclusion between checking of skip or signal arrived state and setting of signal arrived or skip state. In this embodiment, the token handler 124 includes a skip processing state machine that includes blocks 500, 502, 504, and 506 and a token arrived processing state machine that includes blocks 508, 510, 512, and 514, each running independently of other. There are appropriate checks in both state machines to ensure that only one state machine is accessing (reading or writing) the TOKENS_TO_SKIP and TOKENS_ARRIVED CSRs.

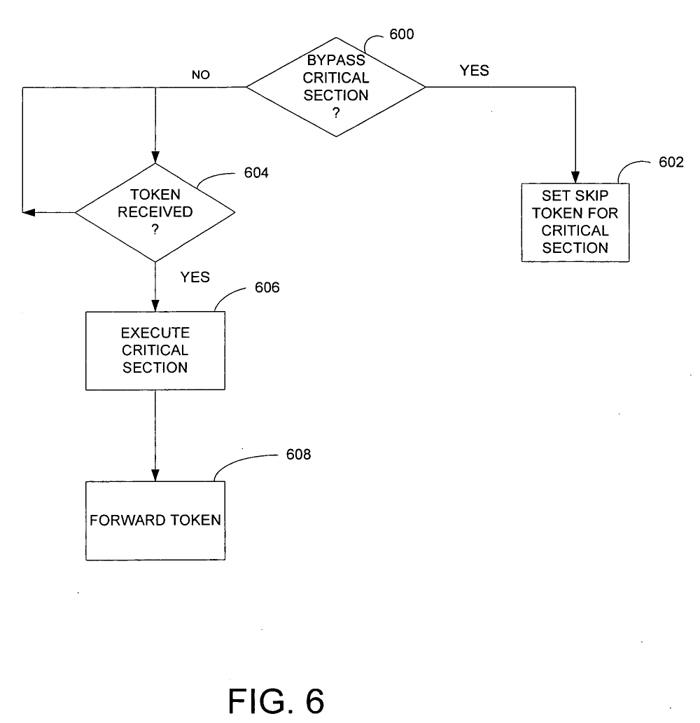

FIG. 6 is a flow chart illustrating an embodiment of a method for using the token handler. As discussed in conjunction with FIG. 4 each critical section has an associated token. Only the thread having the token can access the critical section. Thus, the token is passed between the threads, typically in round robin fashion. A thread that does not need the token can indicate that it is skipping the token by setting a skip bit associated with the token in the TOKENS_TO_SKIP CSR 404 in the token handler.

At block 600, prior to executing the critical section, the thread determines if the critical section is to be bypassed. If so, processing continues with block 602. If not, processing continues with block 604. In one embodiment, a determination as to whether to bypass critical section is made during initialization and a variable is set indicating that the critical section is to be bypassed. This variable is examined prior to executing the critical section.

At block 602, a bit corresponding to the token associated with the critical section is set in the TOKENS_TO_SKIP CSR 404 in the token handler.

At block 604, critical section is to be executed. The thread stalls waiting to receive the token associated with the critical section. Upon receiving the token, processing continues with block 606.

At block 606, the critical section is executed. Processing continues with block 608.

At block 608, after the critical section has been executed, the token is forwarded to the next thread.

A thread that does not need to process a critical section can indicate to a token handler that it will skip the token associated with the critical section. Instead of forwarding the token to a thread that does not need the token; the token handler maintains state information about tokens that are skipped and forwards the token appropriately when it arrives. Thus, a thread that does not need a token does not wait needlessly for that token.

An embodiment has been described for critical sections in a thread for IP header compression and decompression. IP Header compression and decompression may be used for wireless protocols. Critical sections are also used for processing security protocols such as Internet Protocol Security (IPSec), for voice protocols such as Real Time Protocol (RTP) that is used in the Voice over Internet Protocol (VoIP) and for Random Early Detection (RED) type algorithms.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

What is claimed is:

1. An apparatus comprising:
a plurality of threads; and
a token handler capable of managing token passing on behalf of the plurality of threads, a token associated with a critical section, the token handler capable of maintaining a token skip indicator for the token for each of the plurality of threads, the token skip indicator capable of allowing a thread to indicate whether the critical section associated with the token is skipped by the thread.

2. The apparatus of claim 1, wherein the token handler manages a plurality of tokens, each token associated with one of a plurality of critical sections and one of a plurality of token skip indicators.

3. The apparatus of claim 1, wherein the token handler is capable of maintaining an auto-skip indicator to indicate whether the token associated with a skipped critical section is automatically forwarded to a next thread.

4. The apparatus of claim 1, wherein the threads are packet processing threads.

5. The apparatus of claim 1, wherein the token hander is a lightweight thread

6. The apparatus of claim 1, wherein the token skip indicator is stored in a register.

7. The apparatus of claim 1, wherein the critical section imposes a processing order.

8. The apparatus of claim 1, wherein the plurality of threads are ordered using a pool of threads model.

9. The apparatus of claim 1, wherein the plurality of threads are ordered using a hyper task chaining model.

10. A method comprising:
managing token passing on behalf of a plurality of threads, a token associated with a critical section; and
maintaining a token skip indicator for the token for each of the plurality of threads, the token skip indicator capable of allowing a thread to indicate whether the critical section associated with the token is skipped by the thread.

11. The method of claim 10, further comprising:
managing a plurality of tokens, each token associated with one of a plurality of critical sections and one of a plurality of token skip indicators.

12. The method of claim 10, further comprising:
maintaining an auto-skip indicator that indicates whether the token associated with a skipped critical section is automatically forwarded to a next thread.

13. The method of claim 10, wherein the threads are packet processing threads.

14. The method of claim 10, wherein the token hander is a lightweight thread

15. The method of claim 10, wherein the token skip indicator is stored in a register.

16. The method of claim 10, wherein the critical section imposes a processing order.

17. The method of claim 10, wherein the plurality of threads are ordered using a pool of threads model.

18. The method of claim 10, wherein the plurality of threads are ordered using a hyper task chaining model.

19. An article including a machine-accessible medium having associated information, wherein the information, when accessed, results in a machine performing:
managing token passing on behalf of a plurality of threads, a token associated with a critical section; and
maintaining a token skip indicator for the token for each of the plurality of threads, the token skip indicator capable of allowing a thread to indicate whether the critical section associated with the token is skipped by the thread.

20. The article of claim 19, wherein the thread is a packet processing thread.

21. The article of claim 19, wherein the critical section of the thread imposes a processing order.

22. The article of claim 19, wherein the plurality of threads are ordered using a pool of threads model.

23. The article of claim 19, wherein the plurality of threads are ordered using a hyper task chaining model.

24. A system comprising:
a switch fabric through which packets are received for processing;
a plurality of threads for processing the received packets; and
a token handler capable of managing token passing on behalf of the plurality of threads, each token associated with a critical section, the token handler capable of maintaining a token skip indicator per token for each of the plurality of threads, the token skip indicator capable of allowing a thread to indicate whether the critical section associated with the token is skipped by the thread.

25. The system of claim 24, wherein the plurality of threads are ordered using a pool of threads model.

26. The system of claim 24, wherein the plurality of threads are ordering using a hyper task chaining model.

27. An apparatus comprising:
a plurality of processors, each processor comprising:
a plurality of threads; and
a token handler capable of managing token passing on behalf of the plurality of threads, a token associated with a critical section, the token handler capable of maintaining a token skip indicator for the token for each of the plurality of threads, the token skip indicator capable of allowing a thread to indicate whether the critical section associated with the token is skipped by the thread.

28. The apparatus of claim 27, wherein token handlers in the plurality of processors are capable of working together as a group to manage token passing between the plurality of threads associated with the plurality of processors

29. The apparatus of claim 28, wherein the token handlers are assigned to different groups, the token handlers assigned to a group capable of working together to manage token passing between the plurality of threads associated with the token handlers for a token assigned to the group of token handlers.
